(19) United States
(12) Patent Application Publication
(10) Pub. No.: US 2010/0231586 A1
(43) Pub. Date: Sep. 16, 2010

(54) Processing Graphics Primitives in an Epsilon View Volume

(75) Inventor: Michael E. Weiblen, Black Hawk, CO (US)

Correspondence Address: Georgios A. Georgakis;Chowdhury & Georgakis, PC, PO BOX 90277, AUSTIN, TX, 78709-0277, US

(73) Assignee: Zebra Imaging, Inc., Austin, TX (US)

(21) Appl. No.: 12/510,882

(22) Filed: Jul. 28, 2009

Related U.S. Application Data
(63) Continuation of application No. 12/404,160, filed on Mar. 13, 2009.

(51) Int. Cl. G06T 15/20; G06T 17/00

(52) U.S. Cl. 345/420

(57) ABSTRACT

Methods and systems for processing graphics primitives, including determining whether a graphics primitive is, at least partially, within an epsilon view volume, the epsilon view volume being a substantially small volume about a view point; and adding one or more additional graphics primitives in response to determining that the graphics primitive is, at least partially, in the epsilon view volume, the one or more additional graphics primitives being an approximation of the graphics primitive.

### I. PRIORITY

This application is a continuation-in part application of U.S. patent application Ser. No. 12/404,160, filed 13 Mar. 2009, titled “Systems and Methods for Processing Graphics Primitives”, and naming Michael E Weiblen as inventor(s).

The above-referenced patents and/or patent applications are hereby incorporated by reference herein in their entirety.

### II. BACKGROUND

The invention relates generally to the field of processing graphics primitives.

### III. SUMMARY

In one respect, disclosed is a method for processing graphics primitives, the method comprising determining whether a graphics primitive is, at least partially, within an epsilon view volume, the epsilon view volume being a substantially small volume about a view point; and adding one or more additional graphics primitives in response to determining that the graphics primitive is, at least partially, in the epsilon view volume, the one or more additional graphics primitives being an approximation of the graphics primitive.

In another respect, disclosed is a system for processing graphics primitives, the system comprising: one or more processors; and one or more memory units coupled to the one or more processors, the system being configured to: point-reflect a graphics primitive about a point to generate a reflected graphics primitive, the reflected graphics primitive maintaining a depth information of the graphics primitive.

In yet another respect, disclosed is a computer program product stored on a computer operable medium, the computer program product comprising software code being effective to: determine whether the graphics primitive is, at least partially, in the secondary volume; and point-reflect the graphics primitive only in response to determining that the graphics primitive is, at least partially, in the secondary volume to generate the reflected graphics primitive, the reflected graphics primitive being in the primary volume.

Numerous additional embodiments are also possible. In one or more various aspects, related articles, systems, and devices include but are not limited to circuitry, programming, electromechanical devices, or optical devices for effecting the herein referenced method aspects; the circuitry, programming, electromechanical devices, or optical devices can be virtually any combination of hardware, software, and firmware configured to effect the herein referenced method aspects depending upon the design choices of the system designer skilled in the art.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices, processes, or other subject matter described herein will become apparent in the teachings set forth herein.

In addition to the foregoing, various other method, device, and system aspects are set forth and described in the teachings such as the text (e.g., claims or detailed description) or drawings of the present disclosure.

### IV. BRIEF DESCRIPTION OF THE DRAWINGS

Other aspects and advantages of the invention may become apparent upon reading the detailed description and upon reference to the accompanying drawings.

FIG. 1 is a block diagram illustrating a system for processing graphics primitives, in accordance with some embodiments.

FIG. 2 is a block diagram illustrating a system for processing and rendering graphics primitives into hogel data, in accordance with some embodiments.

FIG. 3 is a graphical representation in 4D homogeneous space illustrating examples of an epsilon view volume, a primary view volume, and a secondary view volume, in accordance with some embodiments.

FIG. 4 is a graphical representation illustrating regions in 3D space that may be used to classify and accordingly process graphics primitives, in accordance with some embodiments.

FIG. 5 is a flow diagram illustrating a method for processing graphics primitives, in accordance with some embodiments.

FIG. 6 is a flow diagram illustrating another method for processing graphics primitives during hogel rendering, in accordance with some embodiments.

Brief description for the additional figures is provided in the detailed description section.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the terms “couple,” “couples,” “coupled,” or “coupleable” are intended to mean either an indirect or direct electrical or wireless connection. Thus, if a first device couples to a second device, that connection may be through a direct electrical, optical, wireless connection, etc. or through an indirect electrical, optical, wireless connection, etc. by means of other devices and connections.

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art. Other embodiments may be utilized, and other changes may be made, without departing from the spirit or scope of the subject matter presented here.

In some embodiments, systems and methods are disclosed for processing graphics primitives and more particularly for adding one or more additional graphics primitives in response to determining that a graphics primitive is, at least partially, in a substantially small “epsilon” view volume. In some embodiments, the epsilon view volume may represent a substantially small volume about a view point. In some embodiments, the one or more additional graphics primitives may be an approximation of the graphics primitive.

In some embodiments, the epsilon view volume may represent a substantially small volume about a view point, the view point being a point about which 3D geometry may be projected. Certain projections (such as a perspective projection, for example) may yield unpredictable mathematical behavior for graphics primitives near or at the view point. Perspective projections, for example, involve perspective division or homogeneous normalization as part of the rendering process that may result in a division by zero or a substantially small number. Special treatment of graphics primitives near or at the view point may be thus required for such projections. In some embodiments, therefore, one or more additional graphics primitives may be used either in addition or in place of a graphics primitive that is at least partially within a small epsilon view volume about the view point. In some embodiments, the use of the one or more additional graphics primitives may reduce or eliminate artifacts associated with mathematical singularities, for example, that some projections may exhibit near or at the view point.

In some embodiments, an “epsilon view volume” and one or more additional graphics primitives may be considered where 3D rendering is applied to generating multiple hogel views. For additional discussion on hogel rendering, please see U.S. Pat. No. 6,366,370, filed Apr. 2, 2002, entitled “RENDERING METHODS FOR FULL PARALLAX AUTOSTEREOSCOPIC DISPLAYS” and naming Mark Holzbach, et al. as inventors. The above-referenced patent application is hereby incorporated by reference herein in its entirety.

In hogel rendering embodiments, the epsilon view volume may be a substantially small (in all dimensions, for example) parallelepiped centered around a hogel or a view point. In some embodiments, different types of epsilon view volumes may be used such as a substantially small sphere, a tetrahedron, etc.

A determination may be first made as to whether a graphics primitive is at least partially within the epsilon view volume. If it is determined that a primitive is, at least partially, within the epsilon view volume, two additional, triangular primitives may be generated, for example. The two triangular primitives may be such that when combined, a square is formed across the epsilon view volume. In other embodiments, a single triangle or other combinations of graphics primitives may be used in response to a graphics primitive being, at least partially, in the epsilon view volume. In some embodiments, the additional graphics primitives may be generated in order to reduce or eliminate singularities associated with rendering near or at the hogel view points.

In some embodiments, the one or more additional graphics primitives may be assigned attributes that are interpolations, for example, of the attributes of the vertices of the original graphics primitive. In some embodiments, the attributes of the graphics primitives may include interpolated depth attributes from the original graphics primitive in order to correctly overlay the additional graphics primitives with other primitives in the rendering volume. Other attributes may include texture, color, transparency, etc.

In alternative embodiments, a determination may be first made as to whether a primitive is at least partially within an epsilon region. In some embodiments, the epsilon region may be a region that extends along the holographic surface but has a substantially small width along the view direction perpendicular to the hogel surface. Determining whether a primitive is at least partially within the epsilon region may be used in order to classify the graphics primitives and speed up subsequent processing of the graphics primitives. For example, a determination whether a graphics primitive is within an epsilon view volume may be performed only for primitives that were found to be at least partially within the epsilon region.

In some embodiments, additional graphics primitive processing may be performed. For example, graphics primitives may be point-reflected about a point while maintaining depth information of the graphics primitives. Accordingly, a spatial position of the graphics primitive may change but since the depth information is preserved the relative occlusion between the graphics primitives is preserved, thus resulting in the correct relative overlay of the graphics primitives in 2D projections. In some embodiments, such depth-preserving point-reflection of graphics primitives may be implemented to point-reflect a subset of the graphics primitives during or before the rendering of the graphics primitives into hogel views.

In some embodiments, multiple hogel views on a holographic plane or surface may be rendered by considering virtual cameras on the holographic plane placed at the hogel locations. It should be noted that since a hogel, as implemented, may have a 2D spatial extend, hogel location may refer to the location of the center of the hogel or hogel point.

For each hogel, two additional view volumes may be considered (in addition to the epsilon view volume). A first view may be generated by facing a virtual camera away from one side of the holographic surface, and a second view may be generated by facing the camera away from the other side of the holographic surface. Appropriate transformations to account for the reversed or conjugate view from one of the cameras may be applied. The two additional views may also be referred to as orthoscopic and pseudoscopic views. In some embodiments, rasterization techniques may be used to render the graphics primitives into hogel views.

In alternative embodiments, the graphics primitives may be analyzed and preprocessed prior to or during the rendering in order to optimize the rendering process. Optimizing the rendering process may result, for example, in increased rendering speed and quality. The 3D space may be subdivided into two or more additional regions (in addition to the epsilon region), for example, and the graphics primitives may be preprocessed according to which region, the graphics primitives, at least partially, intersect. Examples of such processing may include moving and/or duplicating the graphics primitives from one region to another region (using depth-preserving point reflections, for example), replacing the graphics primitives with other equivalent graphics primitives, etc. In addition, different rendering techniques (such as different projections, for example) may be implemented in different regions.

In some embodiments, two additional regions may be used: one above and one below the holographic plane in addition to the epsilon region that may extend along the holographic plane. In such embodiments, for each primitive, a determination may be first made as to which region a graphics primitive, at least partially intersects. One of the additional regions, either the region in front or the region behind the holographic surface, may be designated as the primary region while the other region may be designated as the secondary region. In some embodiments, if a primitive is located at least partially in the secondary region, the graphics primitive may be point-reflected about the hogel location, thereby creating an additional graphics primitive that is, at least partially, in the primary region. In some embodiments, the duplication and point-reflection of the graphics primitive maintains the depth attribute of the graphics primitive to ensure proper relative overlay placement of the graphics primitive (over or under, for example) other primitives during the creation of the 2D hogel views.

In other embodiments, the graphics primitives may be duplicated regardless of which additional region the graphics primitives intersect. That is, all the graphics primitives may be duplicated and reflected, thereby duplicating primitives in the primary region to the secondary region and graphics primitives in the secondary region to the primary region.

In some embodiments, appropriately duplicating the graphics primitive information from the secondary region into the primary region allows the use of a single camera (the camera facing the primary region, for example) during the rendering. Doing so may improve the rendering speed and efficiency without the loss of any graphics primitive information.

In some embodiments, the addition, duplication, reflection, and general processing of the graphics primitives may be accomplished using a customized application created and configured to perform this operation. In other embodiments, functionality available in current GPUs may be used implement the graphics primitives processing. For example, geometry shaders provided with certain GPUs (for example, GPUs that support OpenGL version 2 and/or Direct3D version 10 application programming interfaces) may be used to accomplish graphics primitives processing such as the duplication and point reflection as well as other types of graphics primitive processing. In some embodiments, hardware/software on the graphics processing unit, outside of graphics languages such as OpenGL and Direct3D, may be used to implement the processing of the graphics primitives.

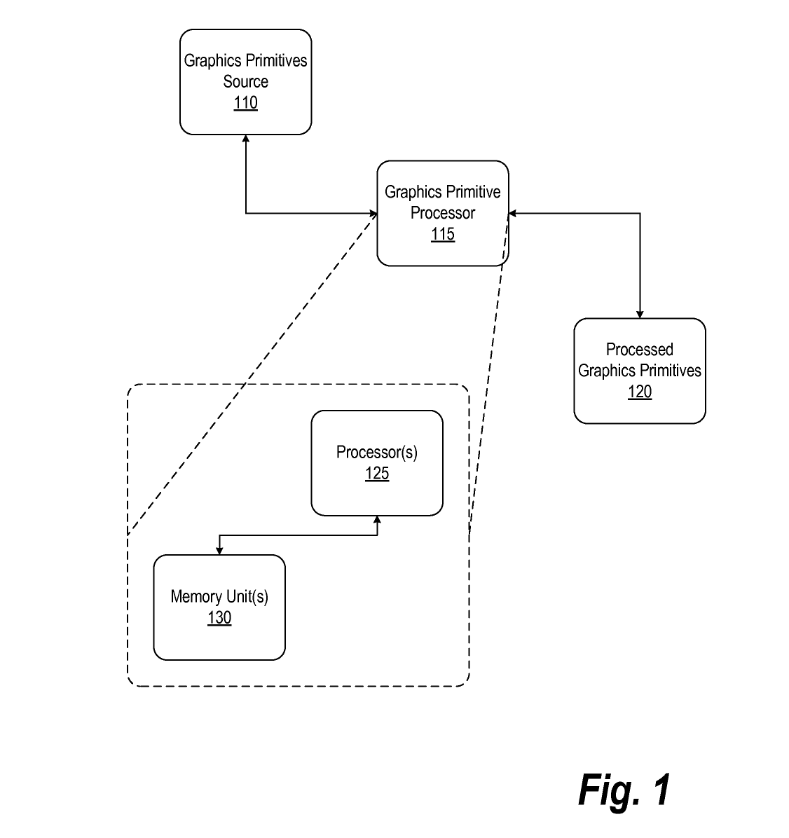

FIG. 1 is a block diagram illustrating a system for processing graphics primitives, in accordance with some embodiments.

In some embodiments, graphics primitive processor 115 is configured to receive graphics primitives from graphics primitive source 110, to process the graphics primitives, and to generate processed graphics primitives 120. In some embodiments, graphics primitive processor 115 may be implemented using one or more processors 125 and one or more memory units 130, which are coupled to one or more processors 125. In some embodiments, graphics primitive processor 115 may be implemented using one or more graphics processing units.

In some embodiments, graphics primitive processor 115 is configured to add one or more additional graphics primitives in response to determining that a graphics primitive is, at least partially, in a substantially small “epsilon” view volume. In some embodiments, the epsilon view volume may represent a substantially small volume about a graphics view point. In some embodiments, the one or more additional graphics primitives may be an approximation of the graphics primitive.

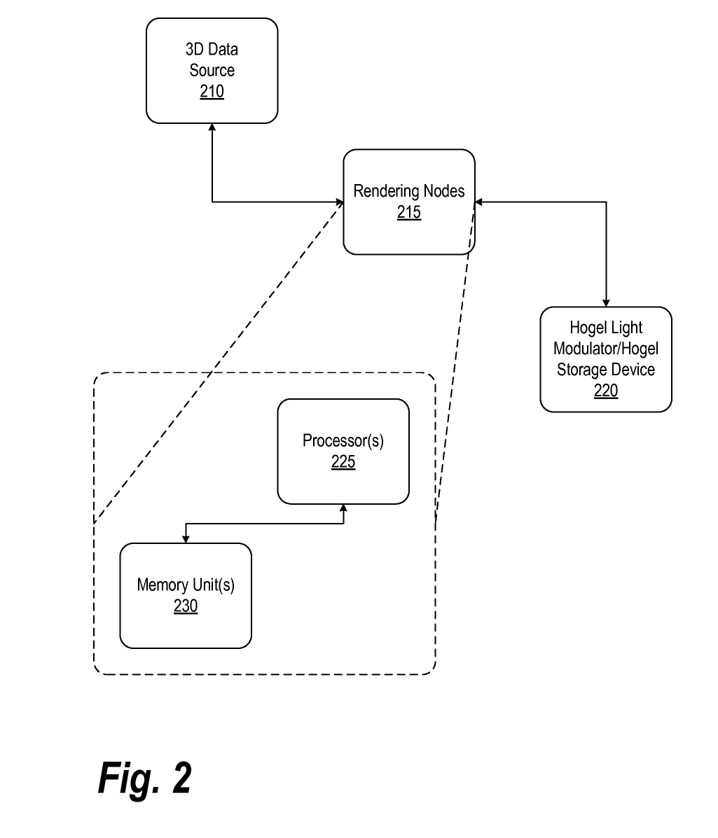

FIG. 2 is a block diagram illustrating a system for processing and rendering graphics primitives into hogel data, in accordance with some embodiments.

In some embodiments, rendering nodes 215 are configured to receive 3D graphics data/commands from 3D data source 210 and to render the 3D data into multiple hogel 2D views. In some embodiments, rendering nodes 215 may comprise one or more graphics processing units configured to convert the 3D data into hogel data in parallel and/or in series. In some embodiments, the rendering nodes may be configured perform additional processing to the graphics primitives provided by 3D data source 210. In some embodiments, the functionality of rendering nodes 215, including the functionality of processing graphics primitives, may be implemented using processors 225 and memory units 230 that are coupled to processors 225. In some embodiments, the functionality of rendering nodes 215 may be implemented using one or more graphics processing units.

In some embodiments, an epsilon region may be considered. In some embodiments, the epsilon region may be a region that extends along the holographic surface but has a substantially small width along the view direction perpendicular to the hogel surface. For example, the epsilon region may be a very small region extending from—ε to ε along the view axis above and below the holographic surface, where ε is a substantially small quantity.

In some embodiments, a determination may be made as to whether a primitive at least partially intersects the epsilon region. If a primitive does intersect the epsilon region, the graphics primitive may be classified as such. In response to being classified, an additional determination may be made, for each hogel view being rendered, as to whether the graphics primitive is at least partially within an epsilon view volume—a substantially small volume centered around the particular hogel. In some embodiments, in response to determining that a graphics primitive is at least partially within an epsilon view volume for a particular hogel, one or more additional graphics primitives may be created and added to set of graphics primitives. In some embodiments, one or more graphics primitives may be added that cover the epsilon region, for example. In embodiments where the epsilon region is a parallelepiped, two triangular primitives may be added that in combination form a square across the epsilon region. In some embodiments, the one or more additional graphics primitives may be assigned attributes (including a depth attribute) that are interpolations, for example, of the attributes of the vertices of the original graphics primitive.

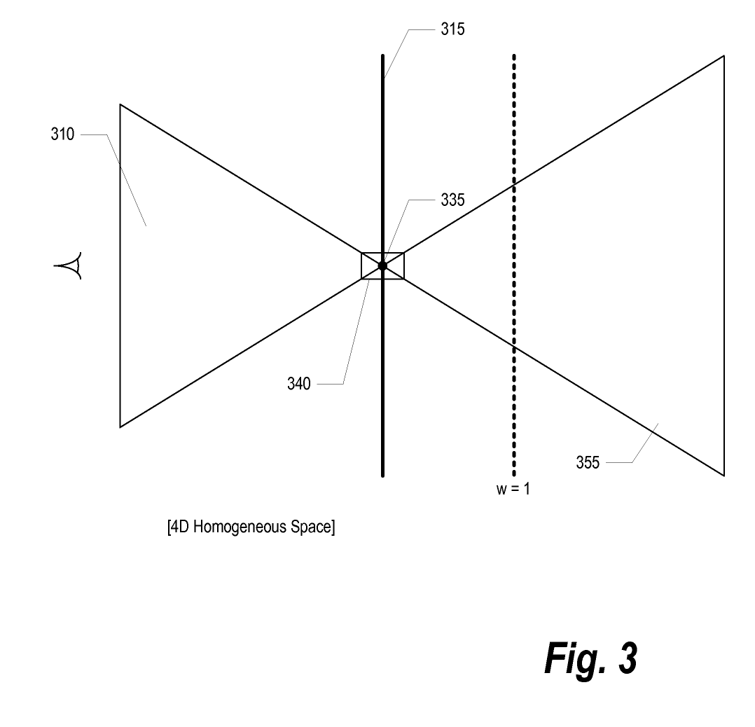

FIG. 3 is a graphical representation in 4D homogeneous space illustrating examples of an epsilon view volume, a primary view volume, and a secondary view volume, in accordance with some embodiments.

The figure illustrates examples of how graphics primitives in different view/rendering volumes may be treated during the rendering of a hogel view for hogel 335, along holographic surface 315. Epsilon rendering volume 340 may be a substantially small rendering volume located very close to the hogel location. Orthoscopic frustum 355 may be on the side of the holographic plane away from the observer and pseudoscopic frustum 310 may be on the opposite side. The figure shows the view/rendering volumes in 4D homogeneous space. In this example, the horizontal axis may represent the homogeneous coordinate (w) and the vertical axis may represent any of the spatial coordinates (x, y, z).

In some embodiments, if a primitive intersects the epsilon view volume, one or more additional graphics primitives may be created and added to the set of graphics primitives. In some embodiments, two triangular primitives may be added that together form a square across the epsilon rendering volume 340. In some embodiments, the one or more additional graphics primitives may be assigned attributes (including depth) that are interpolations of the attributes of the vertices of the original graphics primitive. In some embodiments, the graphics primitives may be assigned a homogeneous coordinate value of w=1, which is equivalent to an orthographic projection for the graphics primitives.

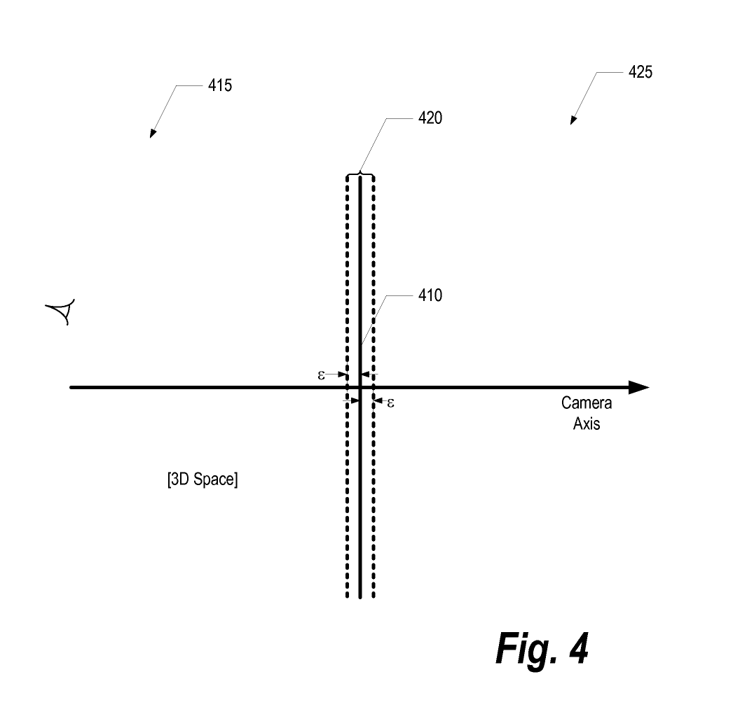

FIG. 4 is a graphical representation illustrating regions in 3D space that may be used to classify and accordingly process graphics primitives, in accordance with some embodiments.

The figure illustrates an example of how a graphics primitive may be classified according to which of one or more regions of space the graphics primitive intersects. In some embodiments, epsilon region 420 as well as primary and secondary regions 415 and 425 may be used in classifying and accordingly processing graphics primitives. Epsilon region 420 may be a very thin region about holographic surface 410, extending a small distance ε on either side of holographic surface 420. Primary and secondary regions 415 and 425 may occupy the remaining regions on either side of the holographic surface (close to the observer and away from the observer respectively).

In some embodiments, each of the graphics primitives may be classified according to which region a primitive at least partially intersects in order to facilitate subsequent processing of the graphics primitives. It should be noted that a graphics primitive may be classified as being at least partially in more than one region if the graphics primitive intersects more than region.

In some embodiments, an initial classification of all the graphics primitives may be performed prior to rendering views for each hogel. For graphics primitives that were classified as being at least partially in epsilon region 420, additional, epsilon region-related processing may be performed for those graphics primitives for each hogel.

For example, for graphics primitives that were classified as being in the epsilon region, an additional determination may be performed, for each hogel view being rendered, to determine whether the graphics primitive is at least partially in a substantially small epsilon view volume about the particular hogel. If a graphics primitive does intersect the epsilon view volume, one or more additional graphics primitives may be created and added to the set of graphics primitives. In some embodiments, two triangular primitives may be added that together form a square across the epsilon rendering volume. In some embodiments, the one or more additional graphics primitives may be assigned attributes (including depth) that are interpolations of the attributes of the vertices of the original graphics primitive. In some embodiments, the graphics primitives may be assigned a homogeneous coordinate value of w=1, which is equivalent to an orthographic projection.

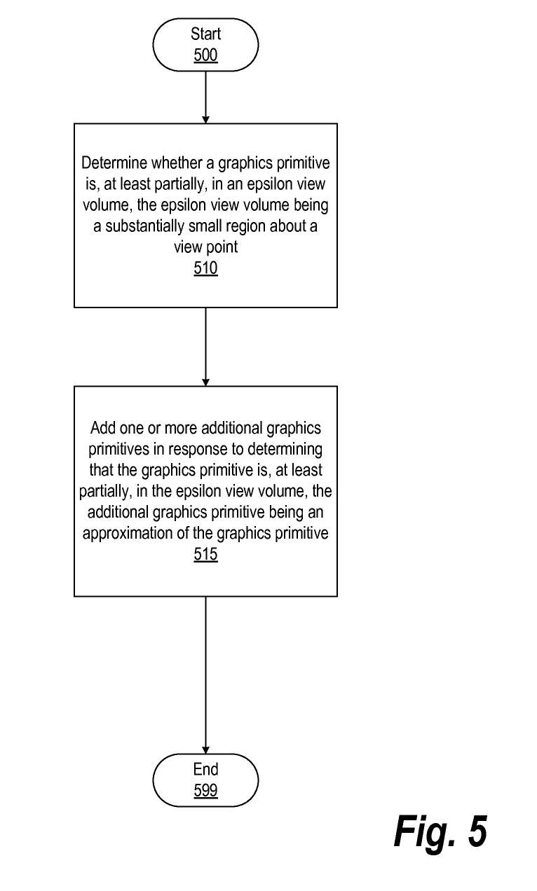

FIG. 5 is a flow diagram illustrating a method for processing graphics primitives, in accordance with some embodiments. It should be noted that, in some embodiments, the methods described here may be performed by the systems described in FIG. 1 or FIG. 2.

Processing begins at 500 where, at block 510, it is determined whether a graphics primitive is, at least partially, in an epsilon view volume, the epsilon view volume being a substantially small volume about a view point.

At block 515, one or more additional graphics primitives are added in response to determining that the graphics primitive is, at least partially, in the epsilon view volume, the additional one or more graphics primitives being an approximation of the graphics primitive.

Processing subsequently ends at 599.

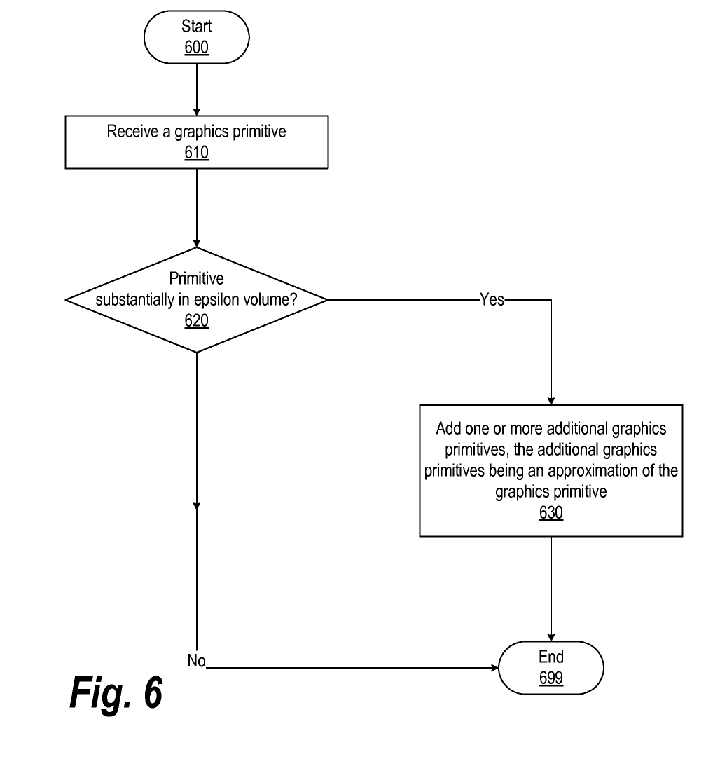

FIG. 6 is a flow diagram illustrating another method for processing graphics primitives during hogel rendering, in accordance with some embodiments. It should be noted that, in some embodiments, the methods described here may be performed by the systems described in FIG. 1 or FIG. 2.

Processing begins at 600 where, at block 610, a graphics primitive is received. At decision 620, a determination is made as to whether the graphics primitive intersects an epsilon volume. The epsilon volume may be a substantially small volume about the particular volume whose view is to be rendered, for example. If the graphics primitive does not intersect the epsilon volume, decision 620 branches to the “no” branch where processing ends at 699.

On the other hand, if the graphics primitive intersects the epsilon volume, processing branches to the “yes” branch where, at block 630, a new graphics primitive is generated and added, the new graphics primitive extending over the epsilon view volume or epsilon rendering volume. In some embodiments, at least a subset of the attributes of the vertices of the new graphics primitive may be an interpolation of the attributes of the vertices of the graphics primitive, including the depth attribute information.

In some embodiments, the determination as to whether a primitive intersects the epsilon volume may be performed as follows. (It should be noted the process that follows represents only one example of how this determination may be accomplished.) A determination may be first made as to whether the graphics primitive intersects the z axis. If the graphics primitive does not intersect the z axis, the processing of the graphics primitive stops. Otherwise, if the graphics primitive intersects the z axis, a determination may be then made as to whether the graphics primitive intersects the z axis within the epsilon volume. Again, if the graphics primitive does not intersect the z axis within the epsilon volume, the processing of that graphics primitive stops. If the graphics primitive intersects the z axis within the epsilon volume, two triangular primitives that form a square, for example, may be added. In some embodiments, the square may extend from −1 to 1 along the x and y axes and may be assigned a z value that is a weighted average of the z values of the original graphics primitive's z values. The z values may be weighted according to the distance of the z axis intersection point to the vertices of the graphics primitive. In some embodiments, the additional graphics primitives may be assigned a homogeneous coordinate (w) value of 1, which is equivalent to an orthographic projection in the epsilon volume. The orthographic projection is in contrast to a perspective projection that may be used, for example, for other rendering volumes.

Processing subsequently ends at 699.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method for processing graphics primitives, the method comprising:
determining whether a graphics primitive is, at least partially, within an epsilon view volume, the epsilon view volume being a substantially small volume about a view point; and
adding one or more additional graphics primitives in response to determining that the graphics primitive is, at least partially, in the epsilon view volume, the one or more additional graphics primitives being an approximation of the graphics primitive.

2. The method of claim 1, where the view point is a hogel on a holographic surface.

3. The method of claim 1, where the additional graphics primitives are substantially in the epsilon view volume.

4. The method of claim 2, where the epsilon view volume is a parallelepiped about the view point, the additional graphics primitives comprising two triangles forming a square across the parallelepiped on the holographic surface.

5. The method of claim 1, where at least a subset of attributes of vertices of the one or more additional graphics primitives is an interpolation of attributes of vertices of the graphics primitive.

6. The method of claim 1, further comprising point-reflecting the graphics primitive about the view point to generate a reflected graphics primitive, the reflected graphics primitive maintaining a depth information of the graphics primitive, the view point being a hogel.

7. The method of claim 6, where the graphics primitive is chosen from a set of one or more graphics primitives, a subset of the one or more graphics primitives located in a primary volume, another subset of the one or more graphics primitives located in a secondary volume, one of the primary volume and the secondary volume being primarily in front of the hogel surface and another of the primary volume and the secondary volume being primarily behind the hogel surface, the method further comprising:
determining whether the graphics primitive is, at least partially, in the secondary volume; and
point-reflecting the graphics primitive only in response to determining that the graphics primitive is, at least partially, in the secondary volume to generate the reflected graphics primitive, the reflected graphics primitive being in the primary volume.

8. A system for processing graphics primitives, the system comprising:
one or more processors; and
one or more memory units coupled to the one or more processors,
the system being configured to:
determine whether a graphics primitive is, at least partially, within an epsilon view volume, the epsilon view volume being a substantially small volume about a view point; and
add one or more additional graphics primitives in response to determining that the graphics primitive is, at least partially, in the epsilon view volume, the one or more additional graphics primitives being an approximation of the graphics primitive.

9. The system of claim 8, where the view point is a hogel on a holographic surface.

10. The system of claim 8, where the additional graphics primitives are substantially in the epsilon view volume.

11. The system of claim 9, where the epsilon view volume is a parallelepiped about the view point, the additional graphics primitives comprising two triangles forming a square across the parallelepiped on the holographic surface.

12. The system of claim 8, where at least a subset of attributes of vertices of the one or more additional graphics primitives is an interpolation of attributes of vertices of the graphics primitive.

13. The system of claim 8, the system being further configured to point-reflect the graphics primitive about the view point to generate a reflected graphics primitive, the reflected graphics primitive maintaining a depth information of the graphics primitive, the view point being a hogel.

14. The system of claim 13, where the graphics primitive is chosen from a set of one or more graphics primitives, a subset of the one or more graphics primitives located in a primary volume, another subset of the one or more graphics primitives located in a secondary volume, one of the primary volume and the secondary volume being primarily in front of the hogel surface and another of the primary volume and the secondary volume being primarily behind the hogel surface, the system being further configured to:
determine whether the graphics primitive is, at least partially, in the secondary volume; and
point-reflect the graphics primitive only in response to determining that the graphics primitive is, at least partially, in the secondary volume to generate the reflected graphics primitive, the reflected graphics primitive being in the primary volume.

15. A computer program product stored on a computer operable medium, the computer program product comprising software code being effective to:
determine whether a graphics primitive is, at least partially, within an epsilon view volume, the epsilon view volume being a substantially small volume about a view point; and
add one or more additional graphics primitives in response to determining that the graphics primitive is, at least partially, in the epsilon view volume, the one or more additional graphics primitives being an approximation of the graphics primitive.

16. The product of claim 15, where the view point is a hogel on a holographic surface.

17. The product of claim 15, where the additional graphics primitives are substantially in the epsilon view volume.

18. The product of claim 16, where the epsilon view volume is a parallelepiped about the view point, the additional graphics primitives comprising two triangles forming a square across the parallelepiped on the holographic surface.

19. The product of claim 15, where at least a subset of attributes of vertices of the one or more additional graphics primitives is an interpolation of attributes of vertices of the graphics primitive.

20. The product of claim 15, the code being further effective to point-reflect the graphics primitive about the view point to generate a reflected graphics primitive, the reflected graphics primitive maintaining a depth information of the graphics primitive, the view point being a hogel.

21. The product of claim 20, where the graphics primitive is chosen from a set of one or more graphics primitives, a subset of the one or more graphics primitives located in a primary volume, another subset of the one or more graphics primitives located in a secondary volume, one of the primary volume and the secondary volume being primarily in front of the hogel surface and another of the primary volume and the secondary volume being primarily behind the hogel surface, the code being further effective to:
determine whether the graphics primitive is, at least partially, in the secondary volume; and
point-reflect the graphics primitive only in response to determining that the graphics primitive is, at least partially, in the secondary volume to generate the reflected graphics primitive, the reflected graphics primitive being in the primary volume.
